(19) United States
(12) Patent Application Publication
(10) Pub. No.: US 2002/0073679 A1
(43) Pub. Date: Jun. 20, 2002

(54) Weed extraction apparatus

(76) Inventor: Mary Ellen Schenck-Williams, Maggie Valley, NC (US)

Correspondence Address: Law Offices of John D.,, Gugliotta, P.E., Esq., 202 Delaware Building, 137 South Main Street, Akron, OH, 44308, US

(21) Appl. No.: 09/742,835

(22) Filed: Dec. 20, 2000

(51) Int. Cl. A01B 1/00

(52) U.S. Cl. 56/378; 172/371

(57) ABSTRACT

A weed extraction apparatus is provided for aiding in the removal of weeds from gardens, flower beds and the like. The invention has two claw like appendages at its lower end, which are held apart by a spring. The claws have multiple tines which mesh in an interlocking pattern to grasp the offending weed and its roots. The claws are forced together by an operating rod connected to a lever located at the upper end of the handle.

### RELATED APPLICATIONS

The present invention was first described in Disclosure Document No. 477,577 filed on Jul. 28, 2000. There are no previously filed, nor currently any co-pending applications, anywhere in the world.

### BACKGROUND OF THE INVENTION

1. Field of the Invention

The present invention relates generally to lawn and garden tools and, more particularly, to a weed extraction apparatus.

2. Description of the Related Art

Planting and caring for a vegetable or flower garden is a task enjoyed by many. Watching the plants develop, while watering, fertilizing, pruning and otherwise nurturing them is a simple pleasure. Recent technological advances in tilling, pest control, hybrid development and the like, have made it almost a foolproof task for anyone to have a beautiful garden. However, one task, and perhaps the most important one that still remains and is difficult for some people, is the process of weeding a garden. While chemical methods do exist, many do nor feel comfortable using such methods, especially on vegetable gardens. The only fool proof method, which also provides immediate results is the action of pulling weeds. This action however, presents great physical difficulties for those with bad backs, weak knees and other physical ailments and disabilities.

Accordingly, there is a need for a means by which one can pull weeds from flower and vegetable gardens from an upright, standing position in a quick and effective manner. The development of the weed extraction apparatus fulfills this need.

A search of the prior art did not disclose any patents that read directly on the claims of the instant invention; however, the following references were considered related. The following patents disclose a weed pulling device with a blade and leverage member: U.S. Pat. No. 5,609,325 issued in the name of De Armond; U.S. Pat. No. 4,281,866 issued in the name of Atcheson; and U.S. Pat. No. 3,976,282 issued in the name of Baker.

The following patents describe a hand weeding tool with a pivotally-hinged jaw and curved blade: U.S. Pat. No. 5,535,833 issued in the name of Mathews; U.S. Pat. No. 5,375,401 issued in the name of Flickinger; and U.S. Pat. No. 2,554,911 issued in the name of Kettel.

U.S. Pat. No. 5,201,168 issued in the name of Jenson discloses an underwater weed cutter driven by an auger with scissor-like cutting blades.

The following patents describe a weed removal device with a blade and rake assembly pivotally-mounted against each other: U.S. Pat. No. 4,157,198 issued in the name of McDaniels; and U.S. Pat. No. 2,504,746 issued in the name of Stecker et al.

U.S. Pat. No. 5,640,836 issued in the name of Lingerfelt discloses a weed puller with a dual blade system pivotally-hinged.

Consequently, a need has been felt for providing a device which allows those who enjoy gardening, but suffer from back pain, weak knees, arthritis, or other physical ailments the ability to quickly and easily remove weeds while standing in an upright position.

### SUMMARY OF THE INVENTION

Therefore, it is an object of the present invention to provide a weed removal device which allows removal of weeds from an upright and standing position.

It is another object of the present invention to provide a weed removal device which does not require a gardener to bend over or get on hands and knees.

It is still another object of the present invention to provide a weed removal device which saves time.

It is still another object of the present invention to provide a weed removal device which works on all types of weeds and can be easily operated by one person.

It is another object of the present invention to provide a weed removal device with grasping claws which are easy to insert in dirt and around weeds.

It is another object of the present invention to provide a weed removal device with grasping claws which have multiple tines for insuring weeds and their roots are entirely removed.

It is another object of the present invention to provide a weed removal device with a long handle which allows a user to remain standing.

It is another object of the present invention to provide a weed removal device with a long handle which provides for increased leverage while inserting and removing the device.

It is another object of the present invention to provide a weed removal device with a long handle which is easy to store and hang.

It is another object of the present invention to provide a weed removal device with a hand-operated lever which is connected to an operating rod.

It is another object of the present invention to provide a weed removal device with a hand-operated lever for opening and closing the grasping claws.

It is another object of the present invention to provide a weed removal device with a hand-operated lever which operates to open and close the grasping claws by simply squeezing the lever.

Briefly described according to one embodiment of the present invention, a weed extraction apparatus is provided for aiding in the removal of weeds from gardens, flower beds and the like. The invention has two claw like appendages at its lower end, which are held apart by a spring. The claws have multiple tines which mesh in an interlocking pattern to grasp the offending weed and its roots. The claws are forced together by an operating rod connected to a lever located at the upper end of the handle. The overall height of the invention is approximately 3 to 4 feet. The user simply positions the invention over the weed and squeezes the lever. This action forces the claws into the ground thus grabbing the weed and its roots. The user simply lifts the invention up, positioning the removed weed over a refuse bin, compost pile, wheelbarrow or the like, and then releases the lever allowing the weed to fall free.

The use of the present invention allows those who enjoy gardening, but suffer from back pain, weak knees, arthritis, or other physical ailments the ability to quickly and easily remove weeds while standing in an upright position.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a perspective view of a weed extraction apparatus according to the preferred embodiment of the present invention;

FIG. 2 is a partial enlarged side elevational view of the weed extraction apparatus according to the preferred embodiment of the present invention;

FIG. 3 is a partial front side elevational view of the present invention according to the preferred embodiment;

FIG. 4 is a partial side elevational view of a claw appendage shown in a closed position;

FIG. 5 is front elevational view of the claw appendages showing their pivotal connection; and

FIG. 6 is a side elevational view of the operating rod according to the preferred embodiment of the present invention.

### DESCRIPTION OF THE PREFERRED EMBODIMENT

1. Detailed Description of the Figures

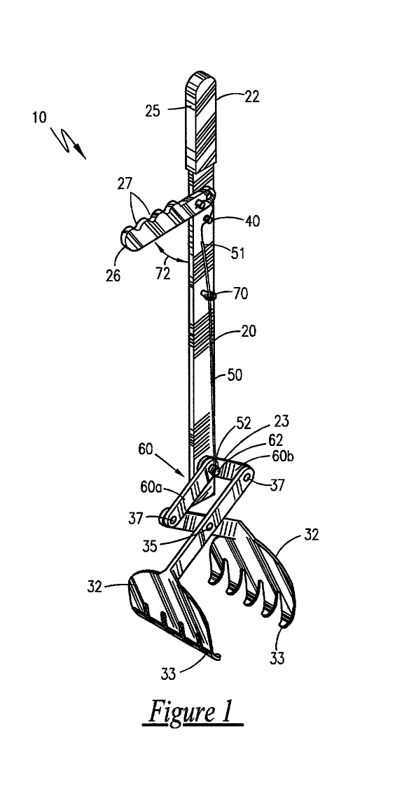

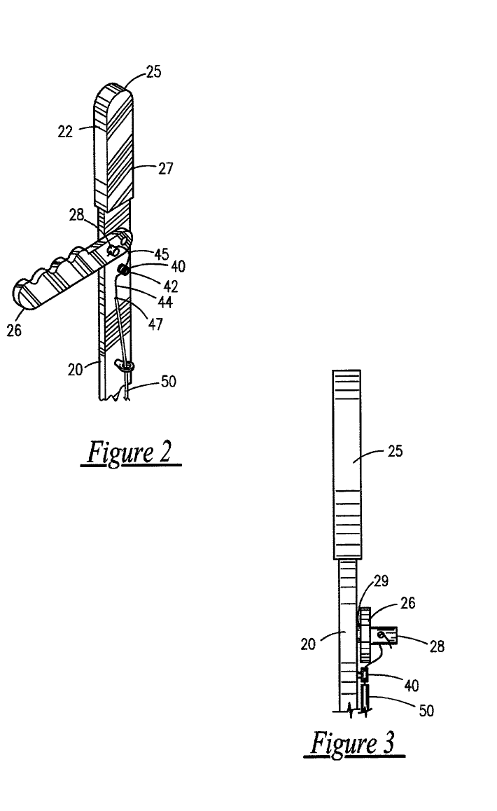

Referring now to FIGS. 1-6, a weed extraction apparatus 10 is shown, according to the present invention, comprised of a linearly elongated handle 20, a pair of movable claw appendages 30, an operating rod 50, and a movable linkage arm 60.

The handle 20 is of a linearly elongated cylindrical configuration, having an anterior end 22 opposite a posterior end 23, and is constructed of a metal material, preferably a rigid aluminum material of high tensile strength. It is envisioned that the handle 20 may also be constructed of wood. The handle 20 has a length measuring approximately 3 to 4 feet. The anterior end 22 of the handle 20 is encapsulated within a sleeve 25 comprised of a thin layer of rubber peripherally adhered thereto, extending a linear distance theredown, so as to allow a user to obtain a non-slip, firm grasp of the handle 20. The handle 20 is further defined as having a linearly elongated lever 26 pivotally mounted to the anterior end 22 thereof, just below the rubber sleeve 25 by a bolt 28. The bolt 28 also serves as a fulcrum for the pair of movable claw appendages 30 (to be described in greater detail below).

A spring 29, shown in FIG. 3, is disposed on the bolt 28 and is adapted so as to connectively embrace the lever 26 in such a manner whereby the lever 26 is biased to a position extending away from the anterior end 22 of the handle 20. The lever 26 includes a plurality of finger-gripping channels 27 formed on an upper surface thereof so as to facilitate gripping of the lever 26.

A small pulley 40 is coupled via a connecting rod 42 to the handle 20, proximately positioned below the lever 26, and is freely rotatable about its connecting rod 42.

A cable 44 operatively engages the pulley 40 and is connected at one end to a side of the lever 26 opposite the finger-gripping channels 27 via a suitable fastener 45, and connected at an opposite end to a cable connecting stem 47, which is in turn connected to an anterior end 51 of the metal operating rod 50.

The metal operating rod 50 is of a linear, rod-like configuration which extends parallel along a linear length of the handle 20, and connects to the movable linkage arm 60 pivotally mounted near the posterior end 23 of the handle 20. The operating rod 50 includes an integral circular loop 53, shown in FIG. 6, formed at a posterior end 52 thereof for being pivotally attached via a bolt 62 to the linkage arm 60.

An eye hook 70 is mounted to an external circumferential sidewall of the handle 20 so as to provide a guide for vertical movement of the operating rod 50 therethrough.

The linkage arm 60 is comprised of a pair of generally, linearly elongated rectangularly-shaped members 60a, 60b, pivotally connected at ends in an overlapping manner to the handle 20 via bolt 62 inserted through the loop 53 of the operating rod 50, through ends of the members 60a, 60b, and mounted to the handle 20 near a posterior end 23 thereof. In a resting position, the members 60a, 60b forming the linkage arm 60 are positioned perpendicularly, as shown in FIG. 1. The operating rod 50 serves to actuate opening and closing of the pair of movable claw appendages 30.

Each claw appendage 30 is of an elongated T-shaped configuration fabricated preferably of stainless steel, and is comprised of a base 32 which includes a plurality of sharpened, uniformly spaced, arcuate-shaped tines 33 extending outwardly therefrom. The claw appendages 30 are pivotally attached via a bolt 35 about a mid-section thereof in an overlapping manner. Ends of each claw appendage 30 opposite the base 32 are pivotally attached via bolts 37 to ends of each member 60a, 60b opposite the members' 60a, 60b overlapping connection point.

A spring 36, shown in FIG. 5, is disposed on bolt 35 and is adapted so as to connectively embrace the claw appendages 30 in such a manner whereby the claw appendages 30 are biased to an open position.

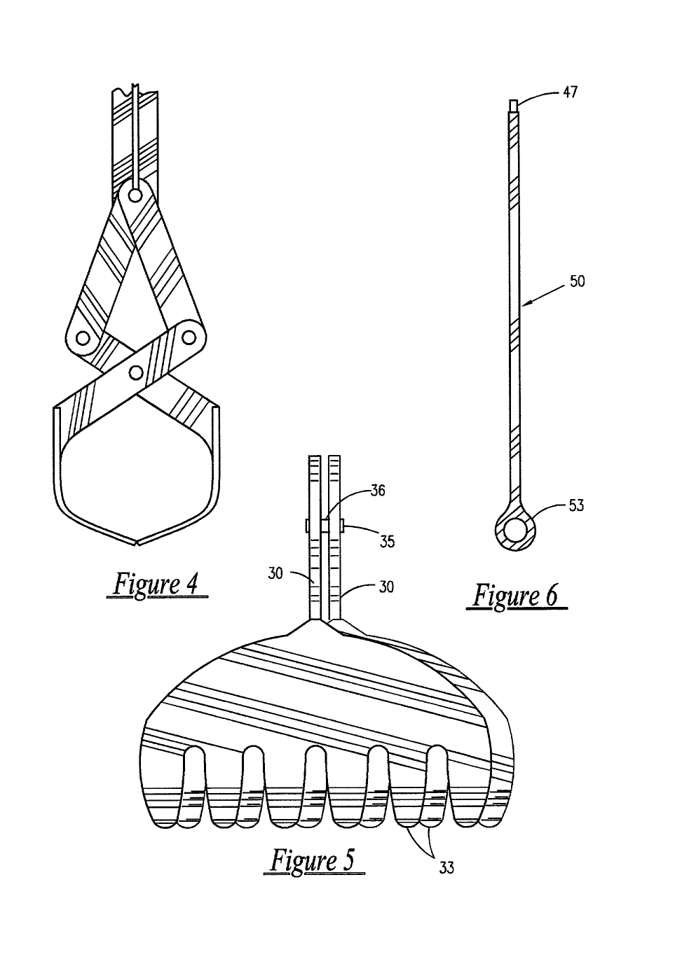

In order to actuate closing of the claw appendages 30, a user squeezes the lever 26 downward in a direction toward the handle 20, illustrated by direction arrow 72 shown in FIG. 1, thereby actuating upward vertical movement of the metal operating rod 50, in turn actuating upward vertical movement of the linkage arm 60. Being pivotally connected to the linkage arm 60, the claw appendages 30 are pulled in an inward direction, wherein the tines 33 thereof mesh in an interlocking fashion, as shown in FIG. 4. Such action of the present invention serves to effectively aid a user in removing weeds from flower and vegetable gardens while standing in an upright position. More specifically, upon the user squeezing the lever 26, the tines 33 of the claw appendages 30 are forced inward to a meshed interlocking closed position into the ground thus grabbing the weed and its roots. The user then simply lifts the present invention thereby effectively extracting the weed, positions the extracted weed over a refuse bin, compost pile, wheelbarrow, or other desired storage area, and releases the lever 26 thereby actuating the claw appendages 30 to their biased open resting position which in turn allows the weed to fall freely. The resultant functionality of the present invention allows the user to effectively remove weeds without bending over.

2. Operation of the Preferred Embodiment

To use the present invention, after placing the open claw appendages 30 over a weed to be removed, the user squeezes the lever 26 whereby the tines 33 of the claw appendages 30 are forced inward to a meshed interlocking closed position into the ground thus grabbing the weed and its roots. The user then simply lifts the present invention thereby effectively extracting the weed, positions the extracted weed over a refuse bin, compost pile, wheelbarrow, or other desired storage area, and releases the lever 26 thereby actuating the claw appendages 30 to their biased open resting position which in turn allows the weed to fall freely.

The use of the present invention allows those who enjoy gardening, but suffer from back pain, weak knees, arthritis, or other physical ailments the ability to quickly and easily remove weeds while standing in an upright position.

Therefore, the foregoing description is included to illustrate the operation of the preferred embodiment and is not meant to limit the scope of the invention. As one can envision, an individual skilled in the relevant art, in conjunction with the present teachings, would be capable of incorporating many minor modifications that are anticipated within this disclosure. Therefore, the scope of the invention is to be broadly limited only by the following claims.

What is claimed is:

1. A weed extraction apparatus comprising:
a handle of a linearly elongated cylindrical configuration, having an anterior end opposite a posterior end;
a pair of movable claw appendages;
a linearly elongated lever pivotally mounted to said anterior end by a bolt, said bolt also serving as a fulcrum for said pair of movable claw appendages;
an operating rod of a linear, rod-like configuration which extends parallel along a linear length of the handle and connects to the movable linkage arm pivotally mounted near the posterior end of the handle;
a spring disposed on said bolt and adapted so as to connectively embrace said lever in such a manner whereby said lever is biased to a position extending away from said anterior end of said handle;
a movable linkage arm.
a pulley coupled via said linkage arm to said handle proximately positioned below said lever and freely rotatable about said linkage arm.

2. The weed extraction apparatus of claim 1, wherein said anterior end of said handle is encapsulated within a sleeve comprised of a thin layer of rubber peripherally adhered thereto, extending a linear distance theredown, so as to allow a user to obtain a non-slip, firm grasp of said handle.

3. The weed extraction apparatus of claim 1, wherein said lever includes a plurality of finger-gripping channels formed on an upper surface thereof so as to facilitate gripping of the lever.

4. The weed extraction device of claim 3, further comprising a cable operatively engaged with said pulley and connected at one end to a side of said lever opposite said finger-gripping channels, and connected at an opposite end to a cable connecting stem, which is in turn connected to an anterior end of said operating rod.

5. The weed extraction device of claim 1, wherein said linkage arm is comprised of a pair of generally, linearly elongated rectangularly-shaped members pivotally connected at ends in an overlapping manner to the handle, wherein said operating rod serves to actuate opening and closing of the pair of movable claw appendages.

6. The weed extraction device of claim 1, wherein each claw appendage has an elongated T-shaped configuration comprised of a base which includes a plurality of sharpened, uniformly spaced, arcuate-shaped tines extending outwardly therefrom.
